(19) United States
(12) Patent Application Publication
(10) Pub. No.: US 2016/0160712 A1
(43) Pub. Date: Jun. 9, 2016

(54) DECOMPRESSION APPARATUS

(71) Applicant: FUJI JUKOGYO KABUSHIKI KAISHA,, Tokyo (JP)

(72) Inventor: Shigeatsu HONGO, Tokyo (JP)

(73) Assignee: FUJI JUKOGYO KABUSHIKI KAISHA, Tokyo (JP)

(21) Appl. No.: 14/946,881

(22) Filed: Nov. 20, 2015

(30) Foreign Application Priority Data
Dec. 8, 2014 (JP) 2014-247987

(51) Int. Cl. F01L 13/08; F02N 19/00

(52) U.S. Cl. CPC F01L 13/08; F02N 19/004

(57) ABSTRACT

A decompression apparatus includes: a cam shaft having exhaust cams that each open an engine exhaust valve; a release pin rotatable about an axis parallel to the cam shaft between decompression and decompression release positions; a decompression plate fixed to the cam shaft with an opening where the cam shaft is inserted; a weight swingably attached to the decompression plate, radially outward by a centrifugal force; a biasing unit that biases the weight radially inward; and an interlocking mechanism that rotates the release pin with the rotation of the weight. A first flat section is formed on an inner peripheral edge of the opening. The cam shaft has a second flat section that abuts against the first flat section and a supporting surface on a same plane as the second flat section. The outer peripheral surface of the release pin abuts against and slides on the supporting surface.

### CROSS-REFERENCE TO RELATED APPLICATIONS

The present application claims priority from Japanese Patent Application No. 2014-247987 filed on Dec. 8, 2014, the entire contents of which are hereby incorporated by reference.

### BACKGROUND

1. Technical Field

The present invention relates to a decompression apparatus provided in a four-stroke engine and, more specifically, to a decompression apparatus with a simple structure for mounting on a cam shaft.

2. Related Art

A four-stroke engine, such as being started by a relatively small starter motor or a manual recoil starter, is provided with a decompression apparatus that reduces the cylinder pressure during startup by temporarily opening an exhaust valve in a compression stroke and reduces the torque necessary for cranking.

The decompression apparatus includes, at least, a decompression camshaft that performs decompression by opening the exhaust valve when the speed is equal to or less than a setting, a weight, being swung by a centrifugal force at an increase in the speed, which turns the decompression cam shaft to release decompression, a spring that returns the weight to the initial position when the speed is low.

As a related art concerning a decompression apparatus, for example, Japanese Unexamined Patent Application Publication (JP-A) No. 2011-149340 discloses the structure in which a weight is swingably attached to a cam sprocket that drives an exhaust cam shaft of a single cylinder DOHC engine and a decompression cam shaft is disposed so as to pass through the cam sprocket.

However, for example, in an engine driving the valves of a plurality of cylinders with a single cam shaft, it is required to provide a disc-shaped decompression plate functioning as a base for the decompression apparatus in addition to the cam sprocket in order to perform decompression in each cylinder. The decompression plate is fixed to the camshaft with a weight or the like being provided on the decompression plate in such a case.

For example, JP-A No. 7-026910 discloses fixation of the cam sprocket to the cam shaft by press-fitting using plastic deformation or by spline fitting as a technique for fixing components to the rotary shaft to prevent relative rotation.

In addition, JP-A No. 8-247089 discloses a technique for attaching a blowing fan to a rotary shaft by creating a flat section so that a rotary shaft has a substantially D-shaped cross section and creating another flat section that abuts against the flat section on a blowing fan.

When press-fitting with plastic deformation is used to attach the decompression plate to the cam shaft, the removal or reuse of components becomes difficult when the engine needs repairing or disassembling maintenance.

When spline fitting is used, machining for a spline hole and spline shaft becomes cumbersome.

Further, in the case of employing the D-shaped cross section, unintentional rotation of the decompression plate can be prevented by relatively simple machining. However, it is necessary to form a D-shaped cut flat section in the cam shaft, as well as a supporting surface (motion surface), being formed adjacently, on which a release pin is held and slides. Therefore, a plurality of cutting works is required, which makes the machining cumbersome.

Alternatively, unintentional rotation of the decompression plate may be prevented by using positioning parts, such as a knock pin and a key, however, the number of machining processes as well as the number of parts would increase in this case.

### SUMMARY OF THE INVENTION

It is desirable to provide a decompression apparatus having a simple structure for mounting on a cam shaft.

A first aspect of the present invention provides a decompression apparatus including a cam shaft having at least one exhaust cam that opens an exhaust valve of an engine, a release pin that is rotatable about an axis parallel to a rotational center axis of the cam shaft with respect to a cam shaft, the release pin rotating, in a compression stroke, between a decompression position at which the exhaust valve is temporarily opened and a decompression release position at which the exhaust valve is not opened, a decompression plate that has an opening into which the cam shaft is inserted, the decompression plate being fixed to the cam shaft, a weight that is attached to the decompression plate swingably about an axis eccentric with the rotational center axis of the camshaft, the weight rotating radially outward by a centrifugal force in accordance with an increase in a rotational speed of the cam shaft, a biasing unit that biases the weight radially inward, and an interlocking mechanism that rotates the release pin from the decompression position to the decompression release position in conjunction with the radially outward rotation of the weight. A first flat section is formed on a part of an inner peripheral edge of the opening of the decompression plate. A second flat section that abuts against the first flat section of the decompression plate is formed on the cam shaft. The cam shaft has a supporting surface on a plane on which the second flat section is present, and the outer peripheral surface of the release pin abuts against and sliding on the supporting surface.

The cam shaft may have a flange that projects radially outward in a brim shape and the decompression plate may be made of sintered metal and have a stepped recessed portion that accommodates the flange in the inner peripheral edge of the opening.

### BRIEF DESCRIPTION OF THE DRAWINGS

FIG. 1 is a schematic view from a radial direction of a cam shaft having a decompression apparatus according to an example of the present invention in the decompression state.

FIG. 2 is a schematic view from the direction indicated by arrows II in FIG, 1.

FIG. 3 is a cross sectional view seen from the direction indicated by arrows III in FIG, 2.

FIG. 4 is a cross sectional view seen from the direction indicated by arrows IV in FIG. 1.

FIG. 5 is a perspective view illustrating the appearance of a decompression apparatus according to a first example.

FIG. 6 is a schematic view from a decompression weight side, illustrating the decompression apparatus according to the example in the decompression release state.

FIG. 7 is a cross sectional view seen from the direction indicated by arrows VII in FIG. 6.

FIG. 8 is a schematic view from a decompression cam, illustrating the decompression apparatus according to the example in the decompression release state.

### DETAILED DESCRIPTION

### Example

An example of a decompression apparatus according to the invention will be described below.

The decompression apparatus according to the example is provided in, for instance, a four-stroke DOHC four-valve in-line two-cylinder gasoline engine mounted as a driving power source in a small vehicle such as an ATV.

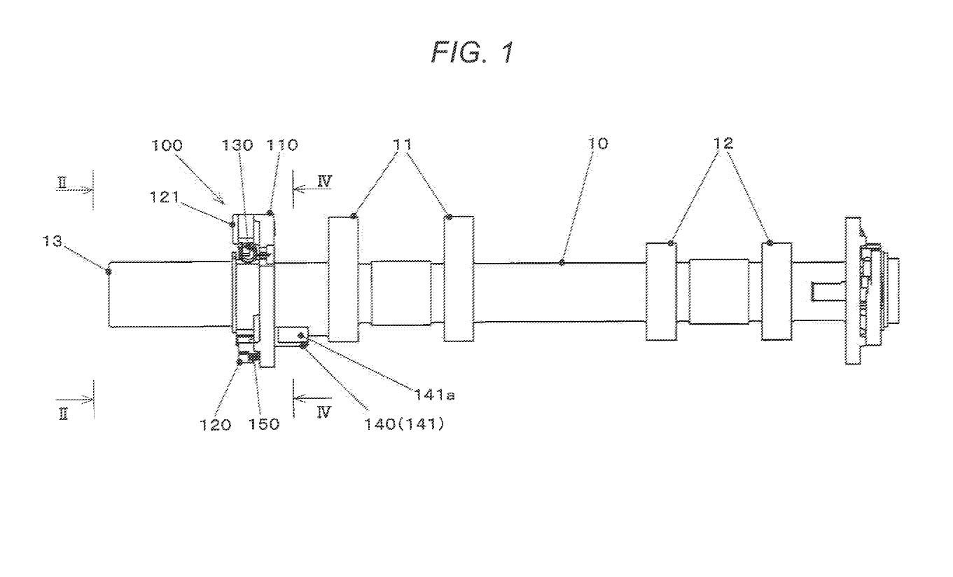

FIG. 1 is a schematic view from a radial direction, illustrating a cam shaft having the decompression apparatus according to the example in the decompression state.

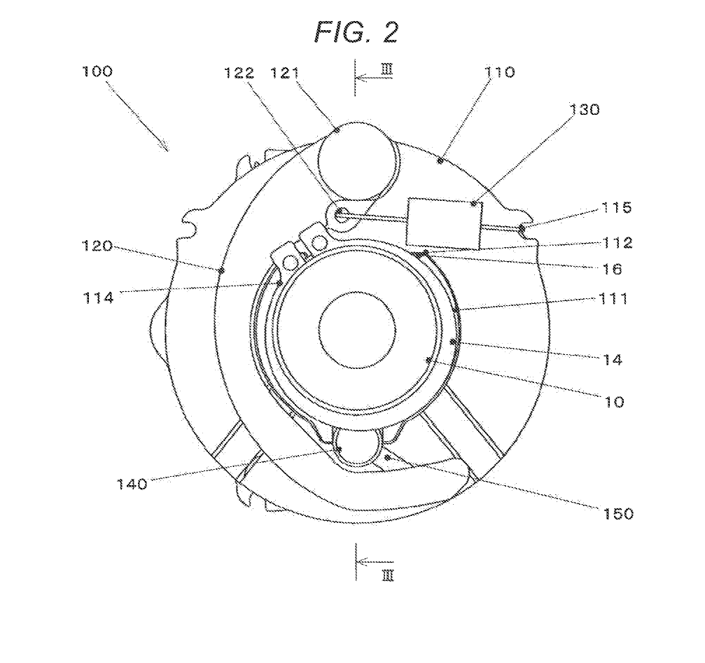

FIG. 2 is a schematic view from the direction indicated by arrows II in FIG. 1.

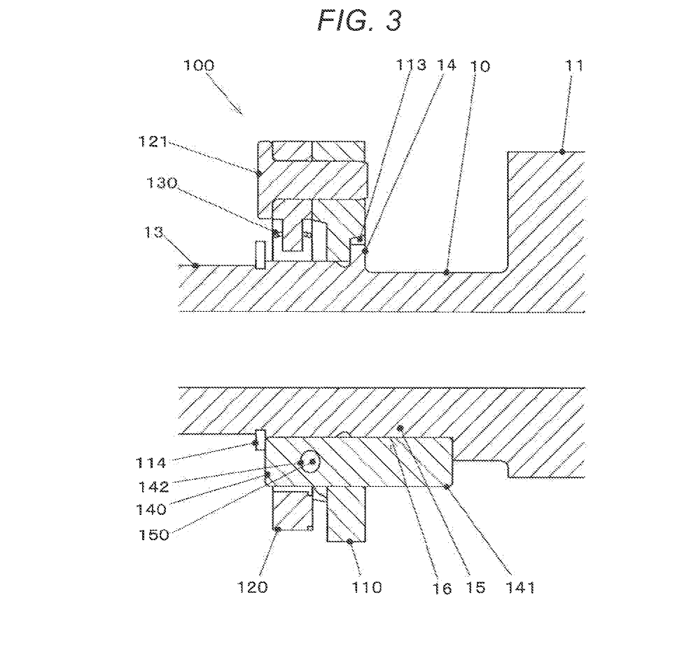

FIG. 3 is a cross sectional view seen from the direction indicated by arrows III in FIG. 2.

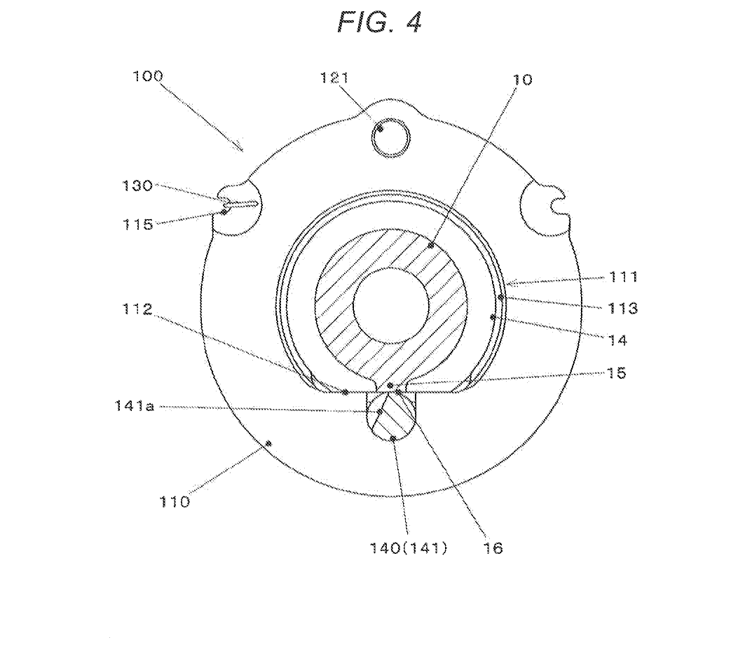

FIG. 4 is a cross sectional view seen from the direction indicated by arrows IV in FIG. 1.

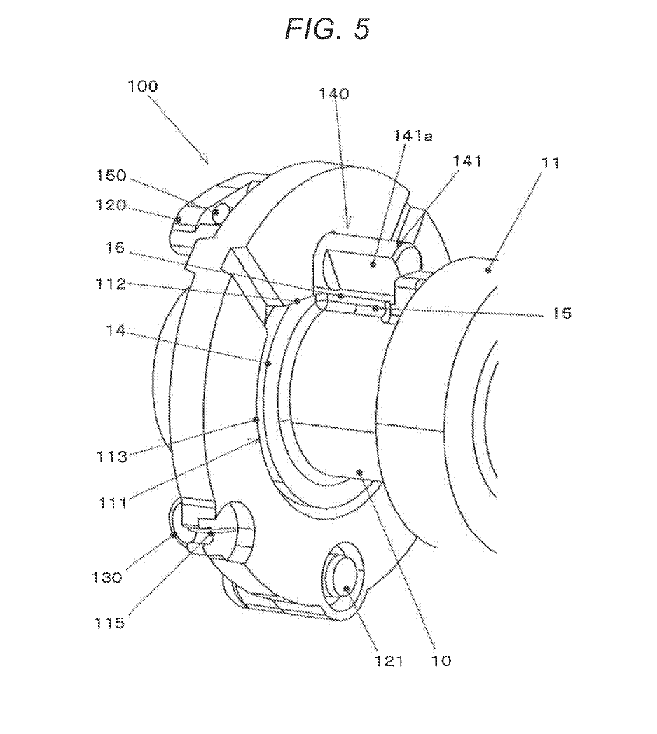

FIG. 5 is a perspective view, seen from a first cylinder, illustrating the appearance of the decompression apparatus according to the example.

A decompression apparatus 100 is provided on an exhaust cam shaft 10 that drives exhaust valves (not illustrated).

The exhaust cam shaft 10 includes first cylinder exhaust cams 11, second cylinder exhaust cams 12, a sprocket mounting section 13, a decompression plate mounting flange 14, a rib 15, a flat section 16, and the like.

The exhaust cam shaft 10 is provided on a cylinder head (not illustrated) so as to be disposed parallel to an intake cam shaft that drives an intake valve.

The exhaust cam shaft 10 rotates in sync with the crank shaft (not illustrated), which is an output shaft of the engine, at a rotational speed one-half that of the crank shaft via a timing chain wound around a cam sprocket (not illustrated) and crank sprocket (not illustrated).

The first cylinder exhaust cam 11 and the second cylinder exhaust cam 12 drive the exhaust valves that open and close exhaust ports through which exhaust gas (burnt gas) from combustion chambers of the first cylinder (not illustrated) and the second cylinder (not illustrated) is emitted.

Each cylinder has two exhaust valves. The first cylinder exhaust cam 11 and the second cylinder exhaust cam 12 having substantially the same shape are provided for each exhaust valve.

Of the exhaust valves for each cylinder, the exhaust valve close to the decompression apparatus 100 is used for decompression.

The sprocket mounting section 13 is provided at an end of the exhaust camshaft 10 close to the first cylinder and the cam sprocket (not illustrated) is attached to this sprocket mounting section 13.

The decompression plate mounting flange 14 (see FIG. 5) is a base on which a decompression plate 110 of the decompression apparatus 100 is mounted.

The decompression plate mounting flange 14 is a planar part protecting radially outward in a brim shape from the outer peripheral surface of the exhaust cam shaft 10.

The decompression plate mounting flange 14 is formed integrally with the body of the exhaust cam shaft 10.

The decompression plate mounting flange 14 on which the decompression apparatus 100 for the first cylinder is mounted is disposed at a position between the first cylinder exhaust cam 11 and the sprocket mounting section 13 in the axial direction of the exhaust cam shaft 10.

The rib 15 is formed by protruding a part of the circumference of the exhaust cam shaft 10 radially outward so as to extend in the axial direction of the exhaust cam shaft 10.

The rib 15 is formed so as to stretch between the decompression plate mounting flange 14 and the first cylinder exhaust cam 11 in the axial direction of the exhaust cam shaft 10.

The flat section 16 is a flat part formed from the projection end (the radially outer end of the exhaust cam shaft 10) of the rib 15 to a part of the outer peripheral edge of the decompression plate mounting flange 14.

The flat section 16 is formed by machining (cutting) the projection end of the rib 15 and the outer peripheral edge of the decompression plate mounting flange 14 along a plane orthogonal to the radial direction of the exhaust cam shaft 10.

Since the flat section. 16 is provided, the decompression plate mounting flange 14 has a so-called D-shape in plan view as seen from the axial direction of the exhaust cam shaft 10.

The flat section 16 also functions as a rotation preventing unit that prevents the decompression plate 110 of the decompression apparatus 100 from rotating relative to the exhaust camshaft 10 and as a supporting surface (motion base) of a release pin 140 that abuts against. and slides on the outer peripheral surface of the release pin 140.

These functions will be described in detail later.

The decompression apparatus 100 reduces the torque necessary for cranking by temporarily opening one exhaust valve in the compression stroke at startup of the engine to let the compressed air escape to the exhaust pipe and thereby reduce the pressure in the cylinder.

The decompression apparatus 100 is provided for each of the first and second cylinders.

The decompression apparatus 100 for the first cylinder will be described below, but the decompression apparatus 100 for the second cylinder also has the substantially the same structure.

The decompression apparatus 100 further includes the decompression plate 110, a decompression weight 120, a spring 130, the release pin 140, an interlocking pin 150, and the like in addition to the exhaust cam shaft 10 described above.

The decompression plate 110 is a base on which the decompression weight 120, the spring 130, the release pin 140, and the like are mounted.

The decompression plate 110 is made of, for instance, sintered metal and formed integrally with the exhaust cam shaft 10 in a disc shape and disposed substantially concentrically with the exhaust cam shaft 10.

The decompression plate 110 has an opening 111 at its center into which the exhaust cam shaft 10 is inserted.

A flat section 112 is formed on a part of the inner peripheral edge of the opening 111, and substantially abuts, in surface contact, against the flat section 16 of the exhaust cam shaft 10.

The flat section 112 is obtained. by forming a part of the outer peripheral edge of the opening 111 in a planar shape along a straight line (chord) parallel to the tangential direction. As a result, the opening 111 has a D-shape in plan view as seen from the axial, direction of the exhaust cam shaft 10.

The surface of the flat section 112 is finished by machining (cutting).

Substantially whole the surface of the decompression plate 110 excluding the flat section 112 is formed during sintering.

A stepped section 113 (see FIG. 5) is formed in the part of the inner peripheral edge of the opening 111 close to the decompression plate mounting flange 14 by denting the surface of the decompression plate 110 in a stepped shape.

The decompression plate mounting flange 14 of the exhaust cam shaft 10 is embedded and accommodated in the stepped section 113.

The decompression plate 110 is fixed to the exhaust cam shaft 10 by the decompression plate mounting flange 14 accommodated in the stepped section 113 and a C-ring 114 provided opposite to the decompression plate mounting flange 14 with respect to the decompression plate 110.

The C-ring 114 is fitted into a circumferential direction groove formed in the outer peripheral surface of the exhaust cam shaft 10.

At this time, the flat section 112 makes surface contact with the flat section 16 of the exhaust cam shaft 10 substantially, and thus the decompression plate 110 is prevented from relatively rotating about the center axis of the exhaust cam shaft 10.

The decompression weight 120 is swingably attached to the decompression plate 110, swings by a centrifugal force in accordance with an increase in the rotational speed of the engine, and drives the release pin 140.

The decompression weight 120 is formed as a metal plate with, for example, an arc-like curved shape substantially along the circumference direction of the decompression plate 110 in a plan view from the axial direction of the exhaust cam shaft 10.

A pivot 121, which is a cylindrical shaft, is provided at one end of the decompression weight 120.

The pivot 121 is a rotary shaft disposed parallel to the exhaust cam shaft 10 and eccentrically with the center axis of the exhaust cam shaft 10, and the decompression. weight 120 can swing (rotate) about the center axis of the pivot 121 within a predetermined angular range with respect to the decompression plate 110.

The pivot 121 has a flange for preventing the decompression weight 120 from dropping on the opposite side of the decompression plate 110 with respect to the decompression weight 120.

The end of the pivot 121. close to the decompression plate 110 is inserted and fixed in the opening formed in the decompression plate 110.

The spring 130 is a tension coil spring provided so as to stretch between an opening 122 formed adjacent to the part of the pivot 121 of the decompression weight 120 close to the exhaust cam shaft 10 and a recessed portion 115 formed in the outer peripheral edge of the decompression plate 110.

The recessed portions 115 is provided at two positions symmetric with respect to the straight line passing through the center axis of the pivot 121 and the center axis of the opening 111 in the decompression plate 110. Accordingly, the decompression apparatus 100 of the first cylinder and the decompression apparatus 100 of the second cylinder can share the decompression plate 110.

The spring 130 biases the decompression weight 120 so that the intermediate part of the decompression weight 120 is pulled toward the center axis of the exhaust cam shaft 10.

When the rotational speed of the exhaust cam shaft 10 is low, the decompression weight 120 is pulled toward the center axis of the exhaust can shaft 10 since the biasing force of the spring 130 becomes larger than the centrifugal force acting on the decompression weight 120.

When the rotational speed of the exhaust cam shaft 10 increases, the centrifugal force acting on the decompression weight 120 becomes larger than the biasing force of the spring 130, so that the decompression weight 120 swings, and the spring 130 is extended.

The release pin 140 is a cylindrical rotary shaft (decompression camshaft) disposed parallel to the exhaust cam shaft 10 so that the outer peripheral surface abuts against the flat section 16 of the exhaust cam shaft 10.

The release pin 140 extends from a portion in the vicinity of the decompression weight 120 to a portion adjacent to the first cylinder exhaust cam 11 in the axial direction of the exhaust cam shaft 10.

The release pin 140 is inserted into the opening formed in the decompression plate 110 and its outer peripheral surface slides on the inner peripheral surface of the opening and the flat section 16, so that the release pin 140 becomes rotatable with respect to the exhaust cam shaft 10 about the center axis thereof.

The release pin 140 has a decompression cam 141, an interlocking pin insertion hole 142, and the like,

When the rotational speed of the engine is low, the decompression cam 141 temporarily pushes a valve lifter (not illustrated) in the compression stroke to open the exhaust valve.

The decompression cam 141 is formed in the vicinity of the end of the release pin 140 close to the first cylinder exhaust cam 11.

A flat section 141a is formed in a part of the outer peripheral surface of the release pin 140, and thus the decompression cam 141 has a substantially D-shaped cross section.

In the decompression state, the part (the outer peripheral surface) of the decompression cam 141 other than the flat section 141a is disposed on the valve lifter side (radially outward of the exhaust cam shaft 10) and projects radially outward of the base diameter of the first cylinder exhaust cam 11.

In this state, when rotating together with the exhaust cam shaft 10, the decompression cam 141 interferes with the valve lifter and temporarily opens the exhaust valve (decompression).

In the decompression release state, the flat section 141a of the decompression cam 141 is disposed on the valve lifter side and remains radially inward of the base diameter of the first cylinder exhaust cam 11.

In this state, the decompression cam 141 does not substantially interfere with the valve lifter, and the exhaust valve is opened only by the first cylinder exhaust cam 11.

The interlocking pin insertion hole 142 is formed at the end of the release pin 140 in the vicinity of the decompression weight 120 and the interlocking pin 150 is inserted into the interlocking pin insertion hole 142.

The interlocking pin insertion hole 142 is a through hole formed substantially along the diameter of the release pin 140.

The interlocking pin 150 is a interlocking member with bridging over the end part of the decompression weight 120, being opposite to the pivot 121, to the interlocking pin insertion hole 142 of the release pin 140. The interlocking pin 150 causes the release pin 140 to rotate about the center axis thereof and move from the decompression position to the decompression release position in conjunction with the swinging of the end of the decompression weight 120 in a direction radially outward of the exhaust cam shaft 10.

The operation of the decompression apparatus 100 according to the example will be described below.

At the startup of the engine, the decompression weight 120 is pulled toward (radially inward of) the center axis of the exhaust cam shaft 10 by the spring 130.

At this time, the part of the decompression cam 141 of the release pin 140 other than the flat section projects radially outward of the base circle of the first cylinder exhaust cam 11 to enter the decompression state (decompression position). When the exhaust camshaft 10 rotates in this state, the decompression cam 141 pushes the valve lifter in the compression stroke, opens the exhaust valve temporarily, and performs decompression.

After that, when the engine starts up (fuel in the engine is perfectly combusted) and the rotational speed increases to a predetermined setting or larger, a centrifugal force acting on the decompression weight 120 becomes larger than the biasing force of the spring 130 and the decompression weight 120 swings about the pivot 121 in a direction in which the other end is displaced radially outward of the exhaust cam shaft 10.

FIG, 6 is a schematic view (equivalent to FIG. 2 in the decompression state) from the decompression weight, illustrating the decompression apparatus according to the example in the decompression release state.

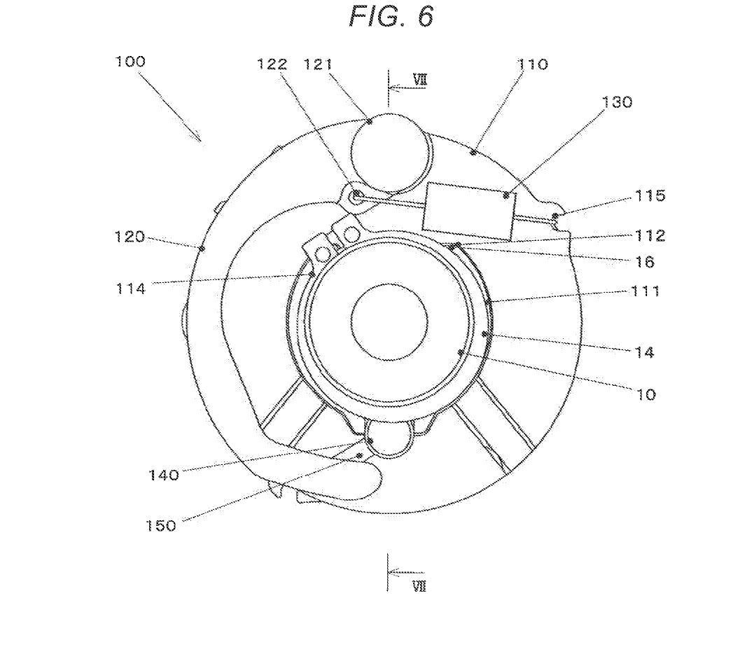

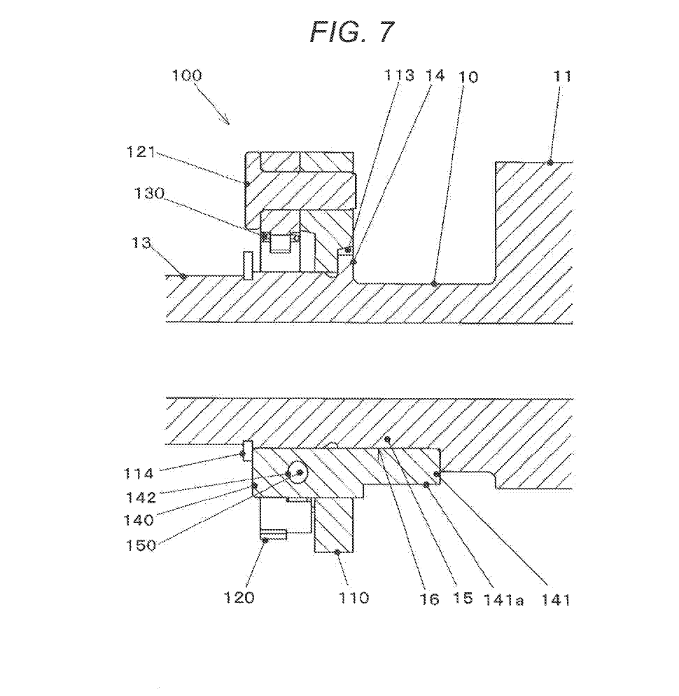

FIG. 7 is a cross sectional view (equivalent to FIG. 3 in the decompression state) seen from the direction indicated by arrows VII in FIG. 6.

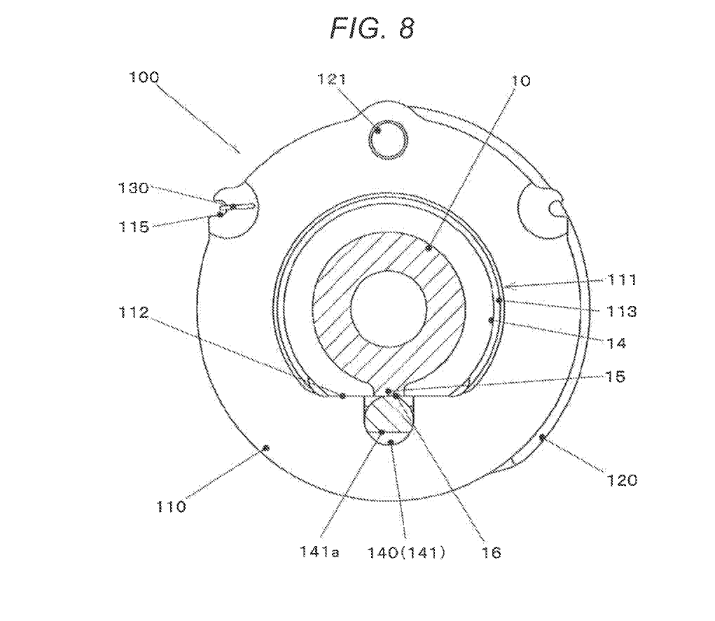

FIG. 8 is a schematic view (equivalent to FIG. 4 in the decompression state) from a decompression cam, illustrating the decompression apparatus according to the example in the decompression release state.

At this time, the release pin 140 is put in the decompression release state (decompression release position) in which the release pin 140 is rotated by the interlocking pin 150 and the decompression cam 141 is pulled within the base circle of the first cylinder exhaust cam 11.

This prevents the decompression can 141 from interfering with the valve lifter and the decompression apparatus 100 stops decompression.

In addition, when the rotational speed of the exhaust cam shaft 10 becomes less than the setting because the engine stops operating, the decompression weight 120 returns to the original decompression state due to the biasing force of the spring 130.

In the example described above, since the flat section 16, which is formed from a flange 14 to the rib 15 along a single plane, prevents the relative rotation of the decompression plate 110 and supports the release pin 140 in the exhaust cam shaft 10, it is possible to prevent the rotation of the decompression plate and support the release pin while facilitating machining and preventing the number of components from increasing.

In addition, since the decompression plate 110 is made of sintered metal and the stepped section 113, which is a stepped recessed portion, is provided in the inner peripheral edge of the opening 111 to accommodate the flange 14 of the exhaust cam shaft 10, it is possible to manufacture the decompression plate 110 at a relatively low cost and achieve the ease of machining, the strength, and the accuracy of mounting on the cam shaft at the same time.

As described above, it is possible to provide a decompression apparatus with a simple structure for mounting on to cam shaft.

### Modifications

The invention is not limited to the above example and may be modified or changed variously. These modifications and changes are also included in the technical scope of the invention.

(1) The structures of the engine and the decompression apparatus are not limited to the above example and may be changed as appropriate. For example, the shapes, the structures, the materials, the production methods, and the number of respective members may be changed as appropriate.

(2) Although, for instance, a DOHC two-cylinder engine is used in the example, an SOHC engine or single-cylinder engine is possible may be used in one example.

(3) The shape of the decompression weight and the interlocking mechanism for the release pin are not limited to the structures of the example and may be changed as appropriate. For instance, a cam groove formed in the decompression weight may guide a cam follower provided on the release pin.

1. A decompression apparatus comprising:
a cam shaft having at least one exhaust cam that opens an exhaust valve of an engine;
a release pin that is rotatable about an axis parallel to a rotational center axis of the cam shaft with respect to the cam shaft, the release pin rotating, in a compression stroke, between a decompression position at which the exhaust valve is temporarily opened and a decompression release position at which the exhaust valve is not opened;
a decompression plate that has an opening into which the cam shaft is inserted, the decompression plate being fixed to the cam shaft;
a weight that is attached to the decompression plate swingably about an axis eccentric with the rotational center axis of the cam shaft, the weight rotating radially outward by a centrifugal force in accordance with an increase in a rotational speed of the cam shaft;
a biasing unit that biases the weight radially inward; and
an interlocking mechanism that rotates the release pin from the decompression position to the decompression release position in conjunction with the radially outward rotation of the weight,
wherein a first flat section is formed on a part of an inner peripheral edge of the opening of the decompression plate,
a second flat section that abuts against the first flat section of the decompression plate is formed on the cam shaft, and
the cam shaft has a supporting surface on a plane on which the second flat section is present, and the outer peripheral surface of the release pin abuts against and sliding on the supporting surface.

2. The decompression apparatus according to claim 1,
wherein the cam shaft has a flange that projects radially outward in a brim shape and
the decompression plate is made of sintered metal and has a stepped recessed portion that accommodates the flange in the inner peripheral edge of the opening.
